(19) United States
(12) Patent Application Publication
(10) Pub. No.: US 2012/0139708 A1
(43) Pub. Date: Jun. 7, 2012

(54) Wireless Hand Gesture Capture

(75) Inventors: Joseph Paradiso, Arlington, MA (US); Rachel Bainbridge, Somerville, MA (US)

(73) Assignee: MASSACHUSETTS INSTITUTE OF TECHNOLOGY, Cambridge, MA (US)

(21) Appl. No.: 13/312,612

(22) Filed: Dec. 6, 2011

Related U.S. Application Data
(60) Provisional application No. 61/420,123, filed on Dec. 6, 2010.

(51) Int. Cl. G06K 7/01

(52) U.S. Cl. 340/10.1

(57) ABSTRACT

In exemplary implementations of this invention, finger and hand gestures are tracked using passive RFID tags. The RFID tags include sensors, and/or can accommodate sensor signals from adjacent sensors. An RFID reader is worn by the user. The tags may be housed in rings worn on a user's fingers, or may be located in other locations on a user's body or clothing. The RFID system may transmit in the UHF range. The sensors may include inertial sensors and proximity sensors. For example, the proximity sensors may be magnetic sensors, capacitive sensors, sensors that detect electrical contact, sensors that detect signal strength, sensors that detect detuning of resonant tags, and other sensors that measure distance or contact between two objects.

### RELATED APPLICATIONS

This application claims the benefit of U.S. Provisional Application Ser. No. 6142013, filed Dec. 6, 2010, the entire disclosure of which is herein incorporated by reference.

### FIELD OF THE TECHNOLOGY

The present invention relates generally to radio frequency identification (RFID).

### SUMMARY

In exemplary implementations of this invention, finger and hand gestures are tracked using passive RFID tags. The RFID tags include sensors and/or can accommodate signals from nearby sensors. An RFID reader is worn by the user. The tags may be housed in rings worn on a user's fingers. Alternately, the tags may be located in other locations on a user's body or clothing.

The RFID transmissions may be in the UHF range, e.g., at about 800 MHz.

The sensors may include inertial sensors and proximity sensors. For example, the proximity sensors may be magnetic sensors, capacitive sensors, sensors that detect electrical contact, sensors that detect signal strength, sensors that detect detuning of resonant tags, and other sensors that measure distance or contact between two objects.

Here are some non-limiting examples, in exemplary implementations of this invention:

Magnetic sensors may detect when a thumb touches or comes close to a finger. For example, two magnets may be housed in a thumb ring, and a magnetic sensor may be housed in a finger ring. The sensor may comprise a Reed switch or Hall effect sensor.

Capacitive sensors may be used to detect finger/thumb proximity. For example, shunt-mode, transmit mode or load mode capacitive sensors may be used.

Hand gestures may be captured, at least in part, by other sensors that measure RSS (received signal strength).

Resonant tags may be used to detect finger/thumb proximity. For example, a resonant tag may be worn on one of the user's finger, and may be detuned by a metal or conductive strip worn on the user's thumb, as the thumb comes closer to that finger.

An electric switch may be used to detect when a finger touches a thumb. For example, two switch contacts may be located on a finger ring, and an electrically conductive strip may be located on a thumb ring. When the two contacts of the switch touch the conductive strip, the switch closes.

Sensors need not be located in a finger ring. They may, instead, be located elsewhere on a user's body or clothing. For example, a proximity-read RFID tag may be affixed to a user's belt, and a reader antenna may be mounted on the user's hand. As the hand is brought near the belt, the tag and thus the hand position are detected. In this example, the sensor configuration can detect a hand gesture in which the hand is brought down to the waist. Optionally, the RFID tag on the belt may include a sensor to detect direct finger or thumb contact.

Inertial sensors in the rings may detect movement or tapping of the fingers. Inertial sensors in the RFID reader or elsewhere on a user's body may be used, e.g. to detect movement artifacts such as movements of the whole body. The inertial sensors may, for example, be 3-axis accelerometers, gyroscopes, or IMUs (inertial measurement units).

Depending on the type of sensor, the sensors may take binary readings (e.g., whether two objects are touching, or not) or analog readings over at least a limited range (e.g., the distance between two objects).

Other types of tags may be employed. For example, active tags may be used. Alternately, battery-assisted passive tags (which are activated by transmissions from an RFID reader) may be used.

In exemplary implementations, this invention has many practical applications. For example, it may be used to facilitate “hands-free” HCI (human-computer interaction). In this “hands-free” approach, a user can interact with a computer by making hand or finger motions in the air, without holding or touching a mouse, keyboard or other conventional computer input technology. The HCI may be used to directly control (or input intent or data into) a device, such as a mobile computing device or wearable computer. Alternately, the HCI may be used to interface with a conventional GUI (graphical user interface). One or more processors may map a detected hand or finger gesture (e.g., hand to waist) to a particular instruction (e.g., to switch a mode of operation) or particular data.

The above description of the present invention is just a summary. It is intended only to give a general introduction to some illustrative implementations of this invention. It does not describe all of the details of this invention. This invention may be implemented in many other ways.

### BRIEF DESCRIPTION OF THE DRAWINGS

FIG. 1 is a high-level block diagram of hardware used in a prototype.

FIG. 2 is a high-level flow chart of functionality of a prototype.

FIG. 3 shows finger rings that house passive RFID tags and sensors.

FIG. 4 shows an RFID reader affixed to a user's sleeve.

FIG. 5 shows passive RFID tags on a user's belt and shirt, in addition to on the user's fingers.

Finger 6 shows a shunt-mode capacitive sensor, for detecting proximity of a thumb to a finger.

FIG. 7 shows a transmit-mode capacitive sensor, for detecting proximity of a thumb to a finger.

FIG. 8 shows a load-mode capacitive sensor, for detecting proximity of a thumb to a finger.

FIG. 9 shows two switch contacts on a finger ring, and a conductive strip on a thumb ring.

FIG. 10 shows a magnetic sensor on a finger ring, and two magnets on a thumb ring.

FIG. 11 shows inertial sensors in passive RFID tags and an RFID reader.

FIG. 12 shows a resonant tag on a finger ring and a metal strip on a thumb ring. As the thumb approaches the finger, the resonant tag is detuned.

FIGS. 13A, 13B, 13C and 13D show antenna locations within an RFID reader, external to an RFID reader, within a passive RFID tag, and external to an RFID tag, respectively.

FIG. 14 shows multiple sensors housed in a single ring.

The above Figures show some illustrative implementations of this invention, or provide information that relates to those implementations. The above Figures do not show all of the details of this invention.

### DETAILED DESCRIPTION

In exemplary implementations of this invention, a wearable system tracks hand gestures with passive RFID sensor tags. The system comprises an ultra-high frequency (UHF) reader and small, passive, finger-worn tags powered by transmitted RF energy, each equipped with one or more sensors for detecting gestures. The system is comfortable and wearable without interfering with other everyday activities. The system can track particular hand movements that could be used to control a wearable computer or aid in interaction with ubiquitous or other wearable devices.

In exemplary implementations, the system tracks movements of fingers and hands while keeping them free of encumbrance or excessive postural constraint. The tags and sensors are housed in rings that can be placed around the user's upper finger joints, and the reader is mounted near the user's sleeve.

In some implementations, the UHF band is used for transmission between the RFID reader and passive RFID tags. A portion of the UHF band in the 800 MHz-960 MHz range is advantageous, because it allows for a reduction in tag size and also in reader size, while still penetrating the human body to some extent, avoiding extreme occlusion problems. Alternately, a lower frequency may be used, which may further reduce occlusion by the body.

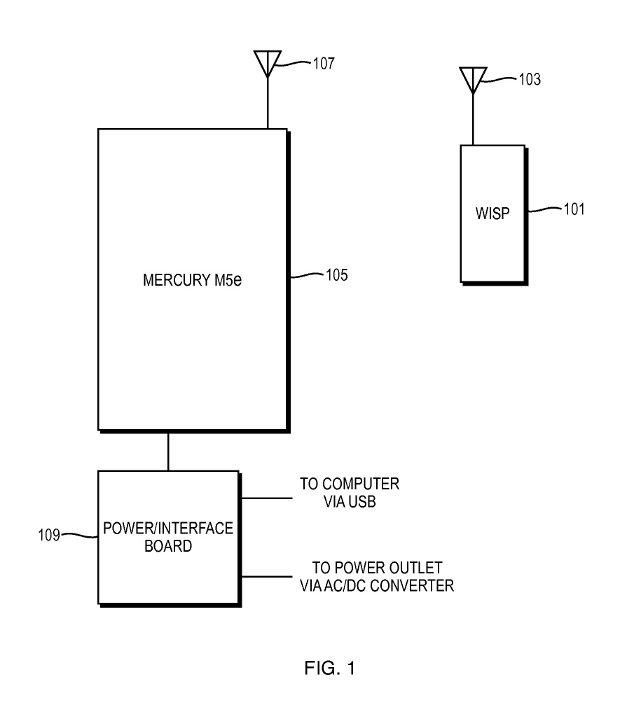

FIG. 1 is a high-level block diagram that shows hardware, in a prototype of this invention. An Intel® WISP® passive RFID tag 101 includes a Johanson Technology® chip antenna 103. The chip antenna 103 receives power wirelessly from a ThingMagic® Mercury® M5e reader 105 with a whip antenna 107 that is connected to the reader by a cable (not shown in FIG. 1). The reader 105 connects to power/interface board 109. The board 109, in turn, connects to a personal computer via USB and to a power source via an AC/DC converter.

The WISP® tag used in the prototype is a microprocessor-equipped UHF tag that includes an accelerometer, can accommodate other sensor signals, and requires no power source except for the reader itself. It measures 1.5 cm×2.5 cm (aside from its large standard dipole antenna, which is removed). The WISP® tag is modified by removing the large standard dipole antenna and replacing it with a chip antenna. In the prototype, all of the finger tags are WISP® tags.

In the prototype, the reader 105 is attached to a ¼-wave monopole whip antenna 107 driven at 916 MHz over 7 inches of cable. The whip antenna 107 is mounted at the wrist and the reader electronics 105 are mounted back up on the arm, avoiding encumbering the hand while incurring under 4% efficiency loss from the cable.

In the prototype, only three fingers are equipped with tags—the index finger, the middle finger and the ring finger. The index finger tag includes a 3-axis accelerometer, enabling full tilt and motion dynamics sensing, while the other two fingers have only a small magnetic reed switch, which can detect contact proximity of a small magnet fixed to the thumb. Velcro® attachments enable the entire rig to be put on within seconds.

In the prototype, in addition to the WISP® tags for the fingers, a standard 916 MHz passive RFID tag is mounted at the user's belt. This tag is read when the hand is near the waist. It provides an easy and reliable means of recognizing a particular hand position (hand at stomach), which is implemented as a “mode change” switch in software for the prototype. Placing such simple proximity-read RFID tags at various parts of the body can reliably detect particular physical posture.

In the prototype, a C# application analyzes the received tag data on a PC laptop, detects particular gestures, and drives mouse operations on a standard Windows® GUI. Alternately, gestures parsed by this system can be used to control wearable/mobile applications.

In the prototype, raw accelerometer data is processed through a deadzone filter to cut drift due to baseline noise, then run through a zero-velocity filter to chase offset drift. Accelerometer signals are then analyzed to determine 2-axis index finger tilt for x/y mouse scrolling as well as index finger taps for selection operations. Bringing the magnetized thumb against the middle finger serves as a mouse click—placing the thumb against the ring finger toggles mouse scrolling on and off. When mouse scrolling is enabled, once the index finger is tilted off vertical beyond the ˜20° deadzone, the mouse scrolls with a velocity proportional to finger inclination and 2-axis scroll direction determined directly by the continuous tilt vector. When scrolling is disabled, index finger taps against various surfaces can be easily detected via a binary threshold on the accelerometer signals, as the acceleration signature has a canonical bipolar peak.

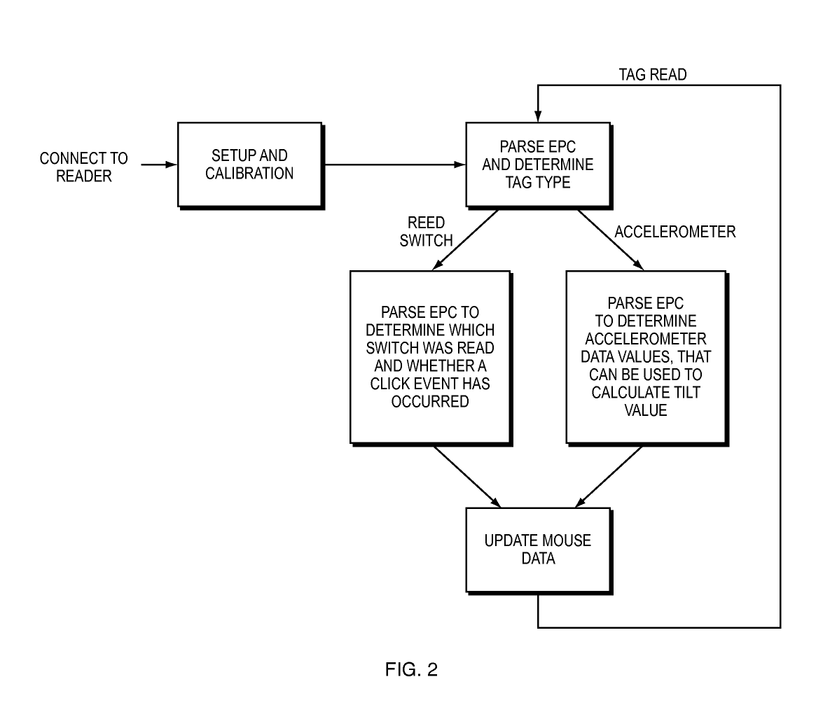

FIG. 2 is a high-level flow chart of functionality of the prototype.

In the prototype, tag data comes from the reader in the form an EPC (electronic product code). The EPC contains a raw value from an ADC, plus information about the type of read that was done, the number of the tag, and the hardware version of the WISP®.

In the prototype, a processor (1) uses data in the EPC to determine the particular sensor (e.g., accelerometer or reed switch) that took the reading, and then (2) parses the data accordingly for use in a GUI. The accelerometer sends 10 bits of data for each channel (x, y and z), and the reed switch sends just 10 bits padded with zeros to fill the remaining space.

The following Figures show exemplary implementations of this invention.

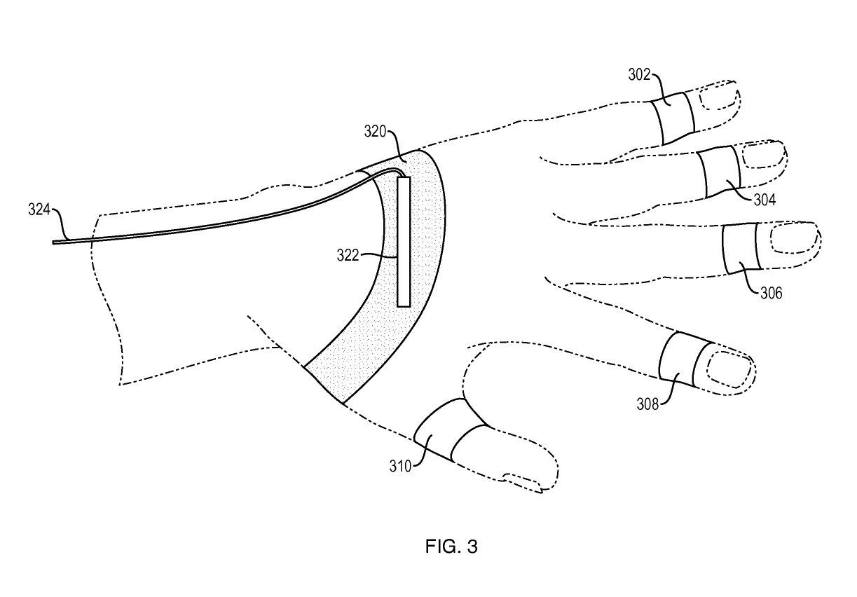

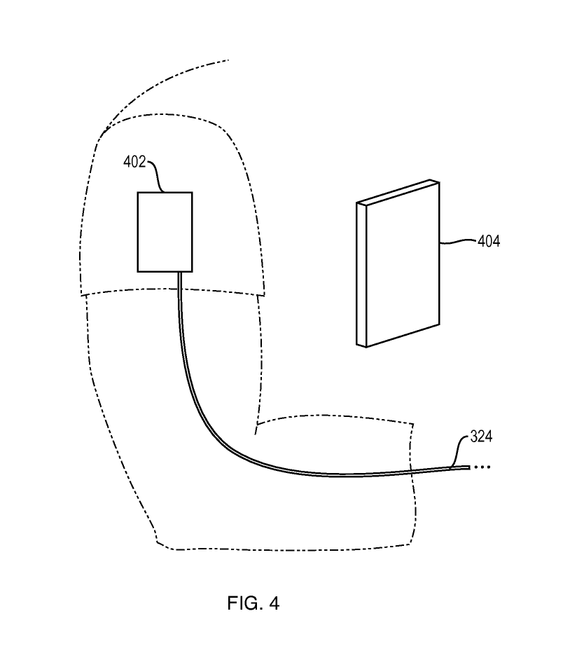

FIG. 3 shows finger rings that house passive RFID tags and sensors. In the example shown in FIG. 3, passive RFID tags are housed in rings 302, 304, 306, 308 around the distal joints of four fingers and in a ring 310 around the distal joint of the thumb 310, one tag per ring. A whip antenna 322 is affixed to an elastic band 320 worn about the wrist or lower hand. A cable 324 connects the antenna 322 to an RFID reader 402 (shown in FIG. 4).

FIG. 4 shows an RFID reader 402 affixed to a user's sleeve. The reader 402 is connected by a cable 324 to the whip antenna 322 (shown in FIG. 3). One or more processors 404 are connected (wirelessly or by a wired connection) to the reader. The processors 404 may be nearby (e.g. worn by the same user) or remote.

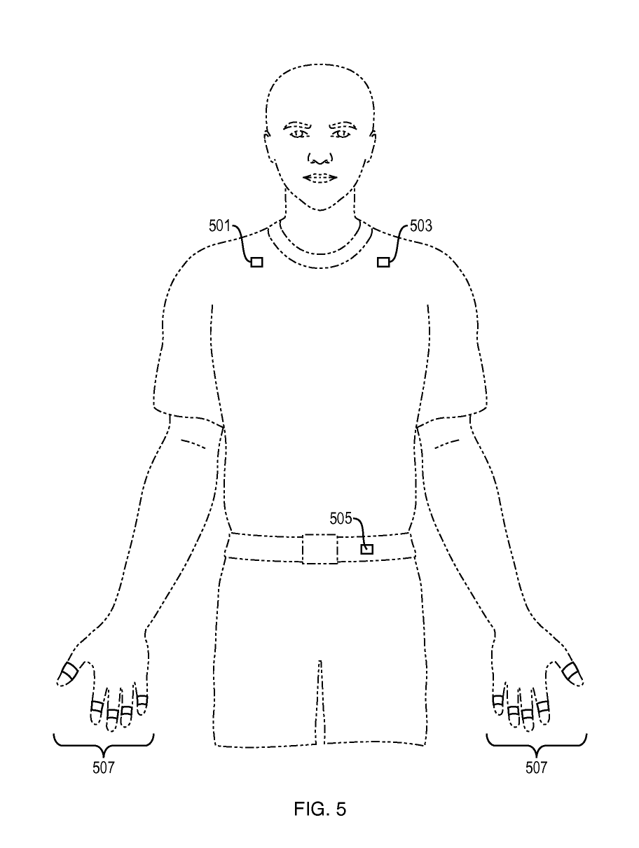

FIG. 5 shows a proximity-read RFID tag 505 affixed to a user's belt. In addition, it shows two proximity-read RFID tags 501, 503 affixed to the user's shirt. These three tags 501, 503, 505 may, for example, be used to detect hand gestures (e.g. hand-to-waist, hand to upper left chest, or hand to upper right chest). As a reader antenna mounted on a user's hand is brought near one of these proximity-read tags, the reader will detect the tag, and thus the hand position. Depending on the particular implementation, the distance at which the reader detects the tag may, for example, be less than 15 centimeters, less than 10 centimeters, less than 8 centimeters, less than 6 centimeters, or less than 4 centimeters. Optionally, these three tags 501, 503, 505 may include sensors that act as a switch, to detect direct contact with a thumb or finger. In FIG. 5, a user also wears RFID tags 507 housed in finger rings.

FIG. 6 shows a shunt-mode capacitive sensor, for detecting proximity of a thumb to a finger. A transmitter plate 602 and a receiver plate 604 are located on a ring 600 on an index finger. The transmitter 602 is driven with an AC waveform creating an electric field around it. The electric field capacitively couples with the receiver 604. A large amount of the field is incident on the receiver from the transmitter in the quiescent state. The thumb shunts some field lines away from the receiver. This causes a reduction in the strength of the received signal. The amount of shunting increases (and signal strength decreases) as the thumb approaches the transmitter and receiver.

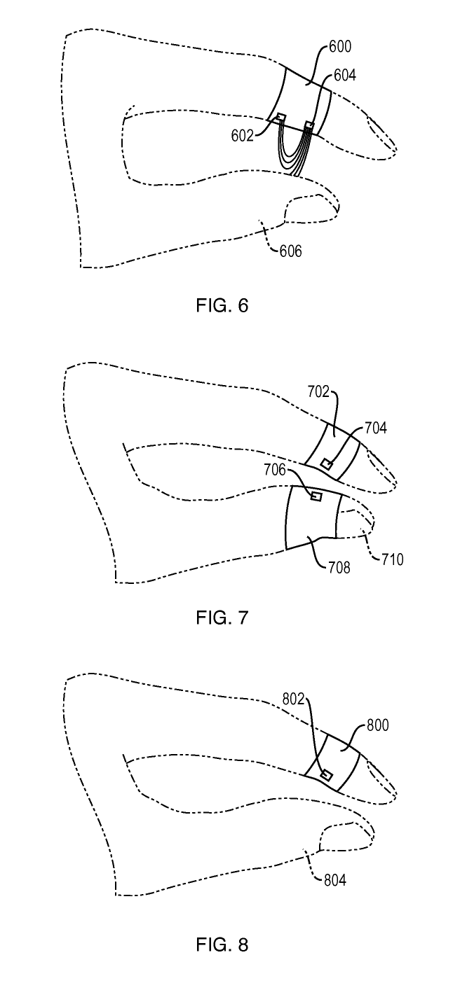

FIG. 7 shows a transmit-mode capacitive sensor, for detecting proximity of a thumb to a finger. Receiver plate 704 is housed on a ring 702 on an index finger. Transmitter plate 706 is housed on a ring 708 on a thumb 710. The transmitter and receiver are capacitively coupled. This coupling increases as the transmitter (on the thumb) comes closer to the receiver (on the index finger).

FIG. 8 shows a load-mode capacitive sensor, for detecting proximity of a thumb to a finger. Plate 802 is housed on a ring 800 on an index finger. The thumb 804 and plate 802 capacitively couple. As the thumb approaches plate 802, the capacitive loading of that plate increases.

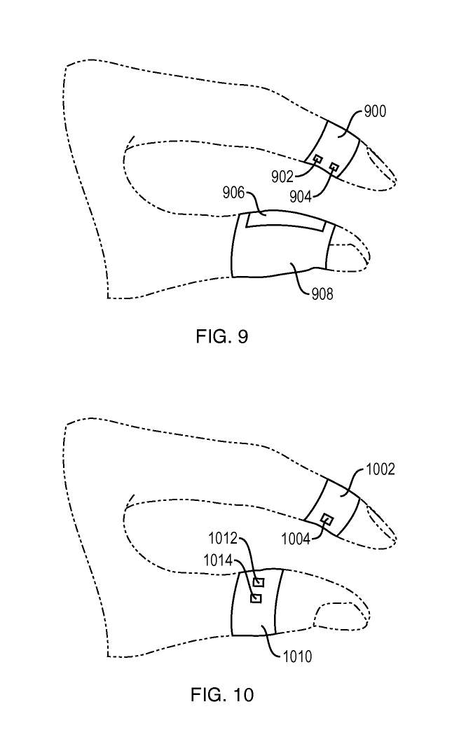

As shown in FIG. 9, two switch contacts 902, 904 may be located on a finger ring 900, and an electrically conductive strip 906 may be located on a thumb ring 908. When the two contacts of the switch touch the conductive strip, the switch closes.

Magnetic sensors may detect when a thumb touches or comes close to a finger. For example, as shown in FIG. 10, two magnets 1012, 1014 may be housed in a thumb ring 1010, and a magnetic sensor 1004 may be housed in a finger ring 1002. The sensor 1004 may comprise a Reed switch or Hall effect sensor.

FIG. 11 shows inertial sensors located in passive RFID tags and an RFID reader. Inertial sensors 1110, 1112, 1114, 1116, and 1118 are located in rings 1100, 1102, 1104, 1106 and 1108, respectively. These sensors may be used to detect movement or tapping of the fingers or thumb.

Inertial sensor 1122 is located in RFID reader 1120. Inertial sensors in the reader or elsewhere on a user's body may be used, e.g. to detect movement artifacts such as movements of the whole body. In each case, the inertial sensors may comprise 3-axis accelerometers, gyroscopes or IMUs.

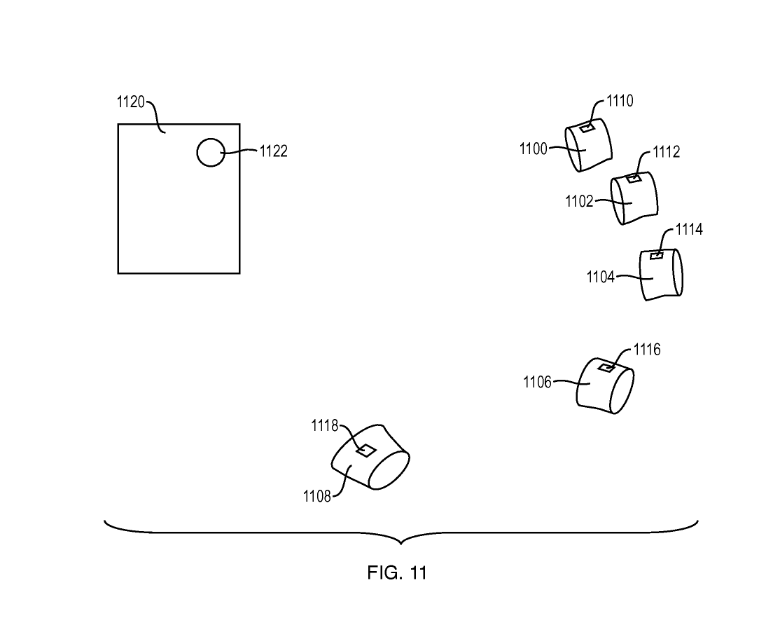

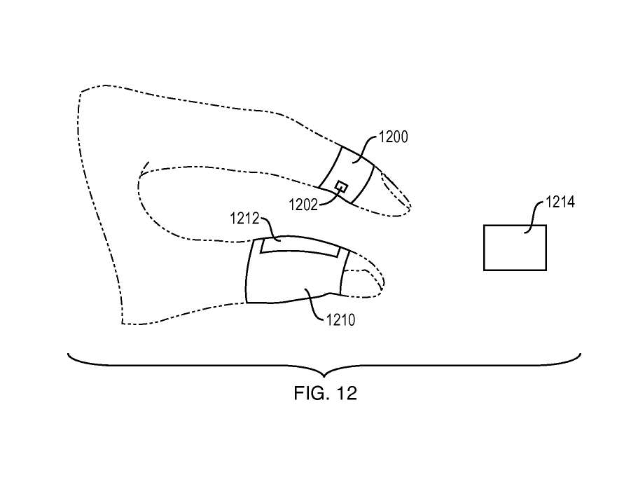

Resonant tags may be used to detect hand/finger proximity. FIG. 12 shows a resonant tag 1202 on a finger ring 1200. It also shows a metal strip 1212 on a thumb ring 1210. An RFID reader 1214 provides power wirelessly. As the thumb approaches the finger, the resonant tag is detuned.

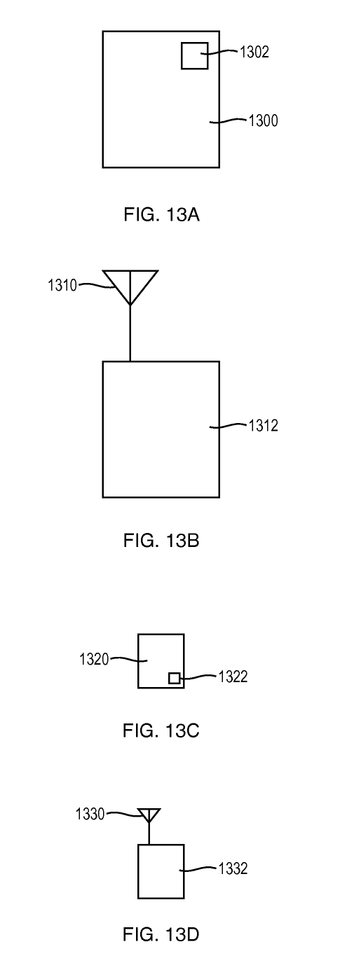

FIGS. 13A, 13B, 13C and 13D show different antenna configurations. Chip antenna 1302 is inside RFID reader 1300. Antenna 1310 is external to RFID reader 1312. Antenna 1322 is inside RFID tag 1320. Antenna 1330 is external to RFID tag 1332. Many other antenna arrangements may be used.

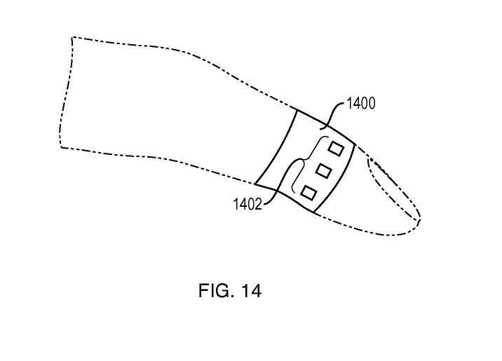

FIG. 14 shows multiple sensors 1402 housed in a single ring 1400. For example, at least one of the sensors may measure RSS (received signal strength).

### Definitions and Clarifications

Here are some definitions and clarifications. As used herein:

An “inertial sensor” means an accelerometer, a gyroscope or an IMU.

The term “include” shall be construed broadly, as if followed by “without limitation”.

The term “or” is an inclusive disjunctive. For example “A or B” is true if A is true, or B is true, or both A or B are true.

“Ring” includes any object that is both (a) annular in shape (or that can take on an annular shape without permanent deformation) and (b) wearable on a human finger. For example, a Velcro® strap that is wearable around a finger is a “ring”, even when it is laid out flat.

### Variants

This invention may be implemented in many different ways. Here are some examples:

Instead of passive RFID tags, either battery-assisted passive tags (that are activated by transmissions from the RFID reader) or active tags may be used.

Passive, magnetically-coupled, near-field RFID transponders may be used as tags. These transponders have some advantages: they are extremely simple; magnetic fields freely propagate through the human body; and the tags can to some extent indicate their distance from the reader by their signal strength. However, these transponders have some limitations: the signal strength of tag can also be tied to its orientation; the tags and reader tend to be large; the reader is slow; and the range of the reader can be too limited.

Different types of tag antennas and reader antennas may be used. For example, meandered dipole antennas, chip antennas or nearfield loops may be used.

In some implementations, hardware may be chosen to reduce power consumption. For example, in the prototype, a WISP® leverages a general-purpose, albeit low power microprocessor (the MPS 430-2132 taking 200 μA/MIP), and the accelerometer (an ADXL330) in a WISP® needs 180 μA. An ASIC customized to this task can be much more power efficient (e.g., state machines used in RFID tags can consume circa 2 orders of magnitude less power. Also, a more energy-conscious accelerometer design can take orders of magnitude less current.

Better antenna design and matching (e.g., chip antennas in the prototypes are monopoles, whereas the WISPs® were set up for a dipole) can help to reduce the size of the tag.

In the prototype, a 916 MHz frequency is used to meet the specifications of off-the-shelf RFID-based hardware used in the prototype. However, a lower frequency can be used with other hardware, and exhibits less absorption by the hand when the hand is between the rings and the reader. A lower powered reader can be used.

Implementations of this invention may vary to meet the needs of particular applications. For example, specific hand gestures can be detected and mapped to functions needed for that application (not just tilt-into-scroll and touch-into-click, in the prototype).

A tag worn on a finger or thumb need not be housed in a rigid ring. For example, it may instead be affixed to elastic material (a Velcro® strap) that is worn on the finger or thumb. Or, for example, a tag may instead be housed in or affixed to a flexible device that is annular in shape.

This invention may be implemented as apparatus comprising, in combination: (a) RFID tags that include, or can receive signals from, sensors, and (b) an RFID reader, wherein (i) the RFID reader can transmit wirelessly to the tags at a frequency of between 700 MHz and 1000 MHz, (ii) a first set of the RFID tags comprises at least one tag, and a second set of the RFID tags comprises at least one tag not included in the first set, (iii) each RFID tag in the first set is, respectively, housed in or attached to a ring, which ring is wearable on at least one of a human's fingers, (iv) each RFID tag in the second set is, respectively, housed in or attached to a device that is wearable adjacent to a portion of the human other than a hand or arm, and (v) one or more of the sensors can each, respectively, measure distance between two objects that are not in direct physical contact with each other, even when the two objects are not moving relative to each other, and are each, respectively, not an inertial sensor. Furthermore, in this apparatus: (1) at least one of the RFID tags may be a passive tag; (2) at least one of the RFID tags may be a battery-assisted tag; (3) at least one of the RFID tags may be an active tags; (4) at least one of the one or more sensors may be a capacitive sensor; (5) at least one of the capacitive sensors may be a shunt-mode capacitive sensor; (6) at least one of the capacitive sensors may be a load-mode capacitive sensor; (7) at least one of the one or more sensors may be a magnetic sensor; (8) at least one of the magnetic sensors may be a Hall effect sensor; (9) at least one of the sensors may be able to measure changes in received signal strength of an RF (radio frequency) signal; (10) the apparatus may further comprise one or more processors for computing the distance, based on data obtained from the sensors; (11) at least one of the one or more processors may be for computing movements of one or more of the fingers and hands, based on data obtained from the sensors; (12) at least one of the one or more processors may be for mapping the movements to a particular instruction or particular data; (13) at least one of the one or more processors may be for measuring detuning of a resonant tag; and (14) an antenna for the RFID reader may be wearable adjacent to a hand or wrist of the user, and the RFID reader may be able to detect one of the second set of RFID tags only when said one of the second set is within a certain distance of the antenna, said distance being less than 15 centimeters.

This invention may be implemented as apparatus comprising, in combination: (a) RFID tags that include, or can receive signals from, sensors, and (b) an RFID reader, wherein (i) a first set of the RFID tags comprises at least one tag, and a second set of the RFID tags comprises at least one tag not included in the first set, (ii) each RFID tag in the first set is, respectively, housed in or attached to a ring, which ring is wearable on at least one of a human's fingers, (iii) each RFID tag in the second set is, respectively, housed in or attached to a device that is wearable adjacent to a portion of the human other than a hand or arm, and (iv) one or more of the sensors can each, respectively, measure distance between two objects that are not in direct physical contact with each other, and are each, respectively, not an inertial sensor. In this example, the RFID reader may transmit wirelessly to the tags at a frequency of between 700 MHz and 1000 MHz.

This invention may be implemented as a method of measuring distance, by using: (a) RFID tags that include, or can receive signals from, sensors, and (b) an RFID reader, wherein (i) at least one of the objects is a finger or hand of a human, (ii) the RFID reader can transmit wirelessly to the tags at a frequency of between 700 MHz and 1000 MHz, (iii) a first set of the RFID tags is housed in rings, which rings are wearable on at least some fingers of the human, (iv) a second set of the RFID tags, which second set comprises at least one tag, is housed in or on devices that are wearable adjacent to a part of the human other than an arm or hand, and (v) at least one of the sensors can measure distance between two objects that are not in direct physical contact with each other. Furthermore, in this method: (1) at least one of the RFID tags may be a passive tag; and (2) an antenna for the RFID reader may be worn adjacent to a hand or wrist of the user, a detection event, in which the RFID reader detects one of the second set of RFID tags, may occur when said one of the second set is within a certain distance of the antenna, said distance being less than 15 centimeters, and, based on said detection event, a processor may determine a location of the hand or wrist.

### CONCLUSION

It is to be understood that the methods and apparatus which have been described above are merely illustrative applications of the principles of the invention. Numerous modifications may be made by those skilled in the art without departing from the scope of the invention. The scope of the invention is not to be limited except by the claims that follow.

What is claimed is:

1. Apparatus comprising, in combination:
RFID tags that include, or can receive signals from, sensors, and
an RFID reader,
wherein:
the RFID reader can transmit wirelessly to the tags at a frequency of between 700 MHz and 1000 MHz,
a first set of the RFID tags comprises at least one tag, and a second set of the RFID tags comprises at least one tag not included in the first set,
each RFID tag in the first set is, respectively, housed in or attached to a ring, which ring is wearable on at least one of a human's fingers,
each RFID tag in the second set is, respectively, housed in or attached to a device that is wearable adjacent to a portion of the human other than a hand or arm, and
one or more of the sensors
can each, respectively, measure distance between two objects that are not in direct physical contact with each other, even when the two objects are not moving relative to each other, and
are each, respectively, not an inertial sensor.

2. The apparatus of claim 1, wherein at least one of the RFID tags is a passive tag.

3. The apparatus of claim 1, wherein at least one of the RFID tags is a battery-assisted tag.

4. The apparatus of claim 1, wherein at least one of the RFID tags is an active tags.

5. The apparatus of claim 1, wherein at least one of the one or more sensors is a capacitive sensor.

6. The apparatus of claim 4, wherein at least one of the capacitive sensors is a shunt-mode capacitive sensor.

7. The apparatus of claim 4, wherein at least one of the capacitive sensors is a load-mode capacitive sensor.

8. The apparatus of claim 1, wherein at least one of the one or more sensors is a magnetic sensor.

9. The apparatus of claim 8, wherein at least one of the magnetic sensors is a Hall effect sensor.

10. The apparatus of claim 1, wherein at least one of the sensors can measure changes in received signal strength of an RF (radio frequency) signal.

11. The apparatus of claim 1, further comprising one or more processors for computing the distance, based on data obtained from the sensors.

12. The apparatus of claim 11, wherein at least one of the one or more processors is for computing movements of one or more of the fingers and hands, based on data obtained from the sensors.

13. The apparatus of claim 11, wherein at least one of the one or more processors is for mapping the movements to a particular instruction or particular data.

14. The apparatus of claim 1, wherein at least one of the one or more processors is for measuring detuning of a resonant tag.

15. The apparatus of claim 1, wherein an antenna for the RFID reader is wearable adjacent to a hand or wrist of the user, and the RFID reader can detect one of the second set of RFID tags only when said one of the second set is within a certain distance of the antenna, said distance being less than 15 centimeters.

16. Apparatus comprising, in combination:
RFID tags that include, or can receive signals from, sensors, and
an RFID reader,
wherein
a first set of the RFID tags comprises at least one tag, and a second set of the RFID tags comprises at least one tag not included in the first set,
each RFID tag in the first set is, respectively, housed in or attached to a ring, which ring is wearable on at least one of a human's fingers,
each RFID tag in the second set is, respectively, housed in or attached to a device that is wearable adjacent to a portion of the human other than a hand or arm, and
one or more of the sensors
can each, respectively, measure distance between two objects that are not in direct physical contact with each other, and
are each, respectively, not an inertial sensor.

17. The apparatus of claim 16, wherein the RFID reader can transmit wirelessly to the tags at a frequency of between 700 MHz and 1000 MHz.

18. A method of measuring distance by using:
RFID tags that include, or can receive signals from, sensors, and
an RFID reader,
wherein
at least one of the objects is a finger or hand of a human,
the RFID reader can transmit wirelessly to the tags at a frequency of between 700 MHz and 1000 MHz,
a first set of the RFID tags is housed in rings, which rings are wearable on at least some fingers of the human,
a second set of the RFID tags, which second set comprises at least one tag, is housed in or on devices that are wearable adjacent to a part of the human other than an arm or hand, and
at least one of the sensors can measure distance between two objects that are not in direct physical contact with each other.

19. The method of claim 18, wherein at least one of the RFID tags is a passive tag.

20. The method of claim 18, wherein:
an antenna for the RFID reader is worn adjacent to a hand or wrist of the user;
a detection event, in which the RFID reader detects one of the second set of RFID tags, occurs when said one of the second set is within a certain distance of the antenna, said distance being less than 15 centimeters; and
based on said detection event, a processor determines a location of the hand or wrist.
